(19) United States
(12) Patent Application Publication
(10) Pub. No.: US 2005/0094185 A1
(43) Pub. Date: May 5, 2005

(54) Job managing apparatus, job managing method, and job managing program

(75) Inventor: Takeshi Hayakawa, Tokyo (JP)

Correspondence Address: ROSSI & ASSOCIATES, P.O. BOX 826, ASHBURN, VA, 20146-0826, US

(73) Assignee: CANON KABUSHIKI KAISHA

(21) Appl. No.: 10/974,562

(22) Filed: Oct. 26, 2004

(30) Foreign Application Priority Data
Oct. 30, 2003 (JP) 2003-370865

(51) Int. Cl. G06F 15/00

(52) U.S. Cl. 358/1.14; 358/1.15

(57) ABSTRACT

A job managing apparatus which is capable of recognizing the status of an external apparatus using a plurality of diagnosing methods in the case where the external apparatus has not performed printing for a predetermined period of time or longer or in the case where an abnormality in the status of the external apparatus is detected, to thereby be able to manage job information in a strict manner. Job information is received from the external apparatus by a communication section. It is detected by a CPU whether or not job information on at least one unprocessed job is included in the received job information. An abnormality in the external apparatus corresponding to the detected job information on at least one unprocessed job is detected by the CPU by using a plurality of protocols. A process is carried out by the CPU to deal with the detected abnormality.

### CROSS REFERENCE TO RELATED APPLICATION

This application claims priority from Japanese Patent Application No. 2003-370865 filed Oct. 30, 2003, which is hereby incorporated by reference herein.

### BACKGROUND OF THE INVENTION

1. Field of the Invention

The present invention relates to a job managing apparatus, a job managing method, and a job managing program connected to a network having a client computer and a server computer, and more particularly to a job managing apparatus, a job managing method and a job managing program which acquire and manage job information when the user uses a peripheral device connected to the network, such as a printer, a scanner, a copying machine, or a multi-function machine (MFP) which have functions of a printer, a scanner, and a copying machine.

2. Description of the Related Art

FIG. 13 is a diagram showing the arrangement of a job account system including a conventional job managing apparatus.

In FIG. 13, reference numerals 101 and 102 are client computers. Reference numeral 100 denotes a server computer which serves as a job managing device. Reference numeral 103 denotes a printer. The client computers 101 and 102, server computer 100, and printer 10 are capable of communicating with each other via a network 105.

The client computer 101 is comprised of an application 101a, a GDI 101b, a job account client application 101c, and a spooler 101d, and the client computer 102 is comprised of an application 102a, a GDI 102b, a job account client application 102c, and a spooler 102d. The server computer 100 is provided with a job account server application 100a.

In the client computer 101 and the client computer 102, different operation systems (OS) operate, which will be referred to as an OS1 and an OS 2, respectively.

In the client computer 101, the application 101a calls an API (application program interface), not shown, to a GDI 101b in the OS1 (a system which carries out graphic drawing in the OS1). The job accounting client application 101c monitors (hooks) the API to count the number of times the API which instructs page feed and sheet discharge has been called, to thereby acquire the number of discharged sheets and the number of sheets in a job issued by the application 101a . The GDI 101b generates and transfers print data to a spooler 101d so that the data can be accumulated in the spooler 101d. The spooler 101d sends the print data to the printer 103 via the network 105 while monitoring the status of the printer 103.

Also, when the application 101a or the application 102a calls the API, not shown, to the GDI 101b or the GDI 102b to issue a print job, the GDI 101b or 102b converts the API called by the application 101a or 102a into print data and transfers the print data to the spooler 102d so that the print data can be accumulated in the spooler 102d. The spooler 102d monitors the status of the printer 103, and sends the print data to the printer 103 via the network 105 if the printer 103 is ready.

The job accounting client application 102c regularly or periodically monitors the spooler 102d, and if there is print data accumulated in the spooler 102d (i.e. if there is a print job related to the print data), the job accounting client application 102c acquires information on the print job by calling the API, to thereby acquire the number of discharged sheets or the number of pages in the print job.

In the job account system including the conventional job managing apparatus, peripheral devices connected to the network have been used by each user at his will.

Also, if any restrictions are imposed on the usage of peripheral devices, the administrator calculates the restrictions depending on usage conditions and notifies the user of the restrictions.

Also, conventionally, an image communicating apparatus which has a communication history storage means which correlates job numbers, a transmission and reception history, and destination address information, and collectively stores them for each protocol, and a destination address information display means for displaying a list of destination information stored in the communication history storage means (refer to Japanese Laid-Open Patent Publication (Kokai) No. 2002-084317, for example).

In the above described conventional job managing apparatus, it has been difficult for the administrator, who administers peripheral devices, to recognize the usage conditions of the peripheral devices according to users or functions which the peripheral device has. In particular, it has been difficult to recognize usage conditions in the case where a printer as a peripheral device has not performed printing for a predetermined period of time or longer, or in the case where there is an abnormality in the status of any peripheral device.

Further, in the image communicating apparatus according to the prior art, although a communication history can be stored for each protocol, when a protocol to be used is changed, it is impossible to determine whether processing of a job has been completed or not and to detect an abnormal device.

### SUMMARY OF THE INVENTION

It is an object of the present invention to provide a job managing apparatus, a job managing method, and a job managing program which are capable of recognizing the status of an external apparatus using a plurality of diagnosing methods in the case where the external apparatus has not performed printing for a predetermined period of time or longer or in the case where an abnormality in the status of the external apparatus is detected, to thereby be able to manage job information in a strict manner.

To attain the above object, in a first aspect of the present invention, there is provided a job managing apparatus capable of connecting to an external apparatus via a network, and having a plurality of protocols, comprising a receiving device that receives job information from the external apparatus to which the job managing apparatus is connected, a detecting device that detects whether or not job information on at least one unprocessed job is included in the received job information, an abnormality detecting device that detects an abnormality in the external apparatus corresponding to the detected job information on at least one unprocessed job, by using the plurality of protocols, and an abnormality handling process executing device that carries out a process to deal with the detected abnormality.

According to this arrangement, it is detected whether job information on at least one unprocessed job is included in job information received from the external apparatus, an abnormality in the external apparatus corresponding to the detected job information on at least one unprocessed job is detected by using a plurality of protocols, and a process for dealing with the detected abnormality is carried out. Therefore, in the case where printing has not been performed for a predetermined period of time or longer, or in the case where an abnormality in the status of the external apparatus is detected, the status of the external apparatus is recognized by a plurality of diagnosing methods, to thereby be able to manage job information in a strict manner.

Preferably, the abnormality handling process executing device comprises a notifying device that notifies a user that there is an abnormality in the external apparatus.

According to this arrangement, the user or the administrator can know an abnormality in the external apparatus more quickly.

Preferably, the job managing apparatus comprises a storage device that stores a result of the process carried out by the abnormality handling process executing device.

According to this arrangement, it is possible to update the contents of processing for dealing with an abnormality in the external apparatus to more suitable ones.

Preferably, the external apparatus comprises a self-recovery process executing device that carries out a self-recovery process when an abnormality occurs therein, and the abnormality handling process executing device comprises an execution command sending device that sends an execution command to the external apparatus so as to cause the external apparatus to carry out a self-recovery process.

According to this arrangement, the external apparatus can recover from a failure without troubling the user or the serviceperson.

Preferably, the job managing apparatus comprises an image forming apparatus.

According to this arrangement, there is no necessity of additionally providing a server computer as the job managing apparatus, and it is possible to construct a job account system at a low cost.

To attain the above object, in a second aspect of the present invention, there is provided a job managing method carried out by a job managing apparatus capable of connecting to an external apparatus via a network, and having a plurality of protocols, the method comprising a receiving step of receiving job information from the external apparatus to which the job managing apparatus is connected, a detecting step of detecting whether or not job information on at least one unprocessed job is included in the received job information, an abnormality detecting step of detecting an abnormality in the external apparatus corresponding to the detected job information on at least one unprocessed job, by using the plurality of protocols, and an abnormality handling process executing step of carrying out a process to deal with the detected abnormality.

According to this arrangement, the same effects can be provided as in the first aspect of the present invention.

Preferably, the abnormality handling process executing step comprises a notifying step of notifying a user that there is an abnormality in the external apparatus.

Preferably, the job managing apparatus comprises a storage device, the method comprising a storage step of storing a result of the process carried out in the abnormality handling process executing step in the storage device.

Preferably, the external apparatus comprises a self-recovery process executing device that carries out a self-recovery process when an abnormality occurs therein, and the abnormality handling process executing step comprises an execution command sending step of sending an execution command to the external apparatus so as to cause the external apparatus to carry out a self-recovery process.

Preferably, the job managing apparatus comprises an image forming apparatus.

To attain the above object, in a third aspect of the present invention, there is provided a job managing program executable by a job managing apparatus capable of connecting to an external apparatus via a network, and having a plurality of protocols, comprising a receiving module for receiving job information from the external apparatus to which the job managing apparatus is connected, a detecting module of detecting whether or not job information on at least one unprocessed job is included in the received job information, an abnormality detecting module for detecting an abnormality of the external apparatus corresponding to the detected job information on at least one unprocessed job, by using the plurality of protocols, and an abnormality handling process executing module for carrying out a process to deal with the detected abnormality.

According to this arrangement, the same effects can be provided as in the first aspect of the present invention.

The above and other objects, features, and advantages of the invention will become more apparent from the following detailed description taken in conjunction with the accompanying drawings.

### BRIEF DESCRIPTION OF THE DRAWINGS

FIG. 1 is a diagram showing the arrangement of a job account system including a job managing apparatus according to an embodiment of the present invention;

FIG. 2 is a block diagram showing the hardware configuration of a server computer appearing in FIG. 1;

FIG. 3 is a diagram showing a memory map assumed in a state in which a job management program according to the present invention is loaded into a RAM and becomes ready to be executed by a CPU;

FIG. 4 is a diagram showing a memory map assumed in a state in which a job management program and related data are stored in an FD, a CD-ROM, or the like;

FIG. 5 is a block diagram showing the hardware configuration of a MFP as a peripheral device;

FIG. 6 is a block diagram showing the configuration of hardware which executes a job account server application appearing in FIG. 1;

FIG. 7 is a diagram showing the structure of one of pieces of information registered in a job history database appearing in FIG. 6;

FIG. 8 is a block diagram showing the configuration of hardware which executes the job account server application appearing in FIG. 1;

FIGS. 9A and 9B are flow chart showing an example of a self-diagnosing process carried out by the server computer appearing in FIG. 1;

FIGS. 10A to 10C are flow charts showing processes carried out by the server computer in the case where there is a device which has not sent any log to the server computer for a predetermined period of time or longer, in which FIG. 10A shows the contents of processing performed in a step S911 in FIG. 9B, FIG. 10B shows the contents of processing performed in a step S912 in FIG. 9B, and FIG. 10C shows the contents of processing performed in a step S913 in FIG. 9B;

FIG. 11 is a diagram showing an example of a processing table executed by the CPU of the server computer based upon the results of processing in FIG. 10;

FIG. 12 is a flow chart showing a process which is carried out by the server computer so as to cause the MFP to execute a self-recovery process; and

FIG. 13 is a diagram showing the arrangement of a job account system including a conventional job managing apparatus.

### DETAILED DESCRIPTION OF THE PREFERRED EMBODIMENTS

The present invention will now be described in detail with reference to the drawings showing a preferred embodiment thereof. In the drawings, elements and parts which are identical throughout the views are designated by identical reference numerals, and duplicate description thereof is omitted.

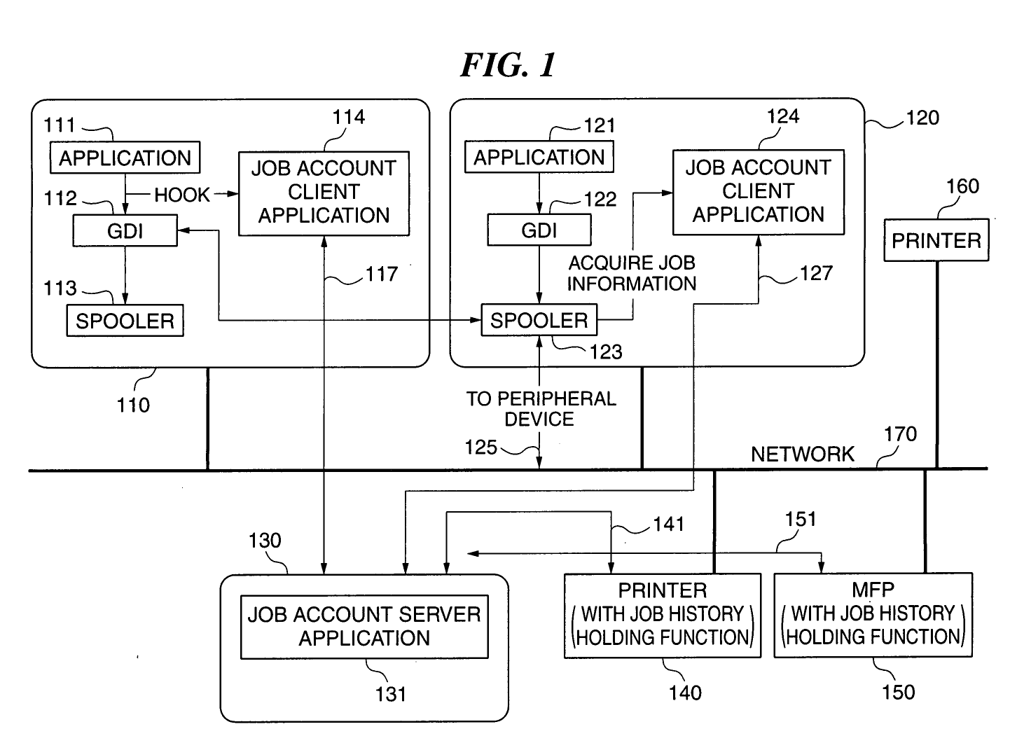

FIG. 1 is a diagram showing the arrangement of a job account system including a job managing apparatus according to an embodiment of the present invention.

In FIG. 1, reference numerals 110 and 120 denote client computers. Reference numeral 130 denotes a server computer as a job managing apparatus. Reference numeral 140 denotes a printer. The printer 140 has a function of holding a printing history (printing history holding function). Reference numeral 150 denotes a MFP (Multi Function Printer). The MFP 150 has a printing function, a copying function, a scanning function, and the printing history holding function. Reference numeral 160 denotes a printer which does not have the printing history holding function. The client computers 110 and 120, the server computer 130, the printers 140 and 160, and the MFP 150 can communicate with each other via a network 170.

The client computer 110 is comprised of an application 111, a GDI 112, a spooler 113, and a job account client application 114. The client computer 120 is comprised of an application 121, a GDI 122, a spooler 123, and a job account client application 124. The server computer 130 includes a job account server application 131.

In the client computer 110, when the application 111 calls the GDI 112, the GDI 112 generates print data according to an instruction from the application 111 and sends the generated print data to the spooler 113. The job account client application 114 monitors (hooks) the application 111 calling the GDI 112 and accumulates job information relating to the print data. The spooler 113 communicates with a peripheral device (e.g. the printer 140, the MFP 150, or the printer 160) via the network 170, and sends the print data if the peripheral device is ready. The job account client application 114 sends the accumulated job information to the job account server application 131 at regular intervals (as indicated by reference numeral 117 in FIG. 1).

In the case where the client computer 120 functions as a print server, the print data generated by the GDI 112 is sent to the spooler 123.

In the client computer 120, the application 121, the GDI 122, and the spooler 123 operate in the same manner as the application 110, the GDI 112, and the spooler 113, respectively. The job account client application 124 monitors the spooler 123 at regular intervals. If there is a print job spooled in the spooler 123, the job account client application 124 acquires information on the print job using an application program interface (API). Specifically, the job account client application 124 acquires information indicative of the number of sheets to be discharged and the number of pages for the print job. Then, the job account client application 124 sends the accumulated job information to the job account server application 131 (as indicated by reference numeral 127 in FIG. 1).

Even if the job account client application 124 does not monitor the spooler 123 at regular intervals, it suffices that an OS has a function of notifying another application that the status of the spooler 123 has changed. It suffices that the OS notifies the job account client application 124 that a print job has been spooled to the spooler 123.

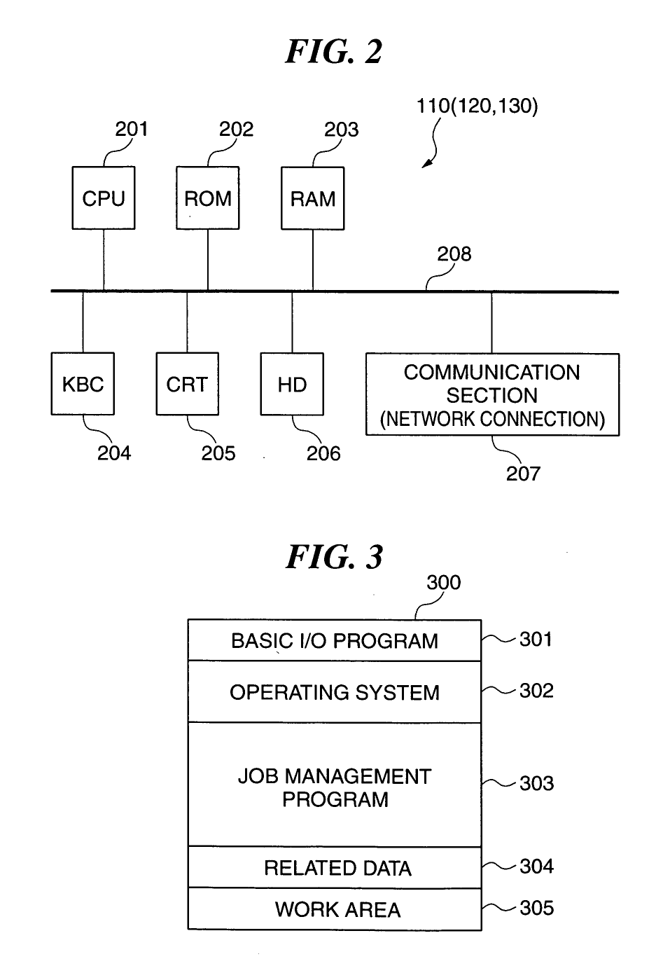

In the server computer 130, the job account server application 131 receives job information from the job account client applications 114 and 124 and stores the job information in a nonvolatile storage device such as a HD 206 in FIG. 2, described later. Further, the job account server application 131 checks whether each peripheral device connected to the network 170 has the job history holding function or not. The job account server application 131 acquires a job history (job information) from a peripheral device which has the job history holding function (as indicated by reference numerals 141 and 151 in FIG. 1).

FIG. 2 is a block diagram showing the hardware configuration of the server computer 130 in FIG. 1.

In FIG. 2, reference numeral 201 denotes a CPU (Central Processing Unit). The CPU 201 controls the overall operation of the server computer 130 and carries out arithmetic operations and others. Reference numeral 202 denotes a ROM (Read Only Memory), which is a storage area where information on e.g. a system boot program is stored. Reference numeral 203 denotes a RAM (Random Access Memory), which is a data storage area with no usage restrictions. An operating system (OS), application programs, device drivers (printer drivers), and communication programs and so forth are loaded into the RAM 203 and executed by the CPU 201.

Reference numeral 204 denotes a KBC (keyboard controller), which receives input data from a keyboard attached to the computer and transmits the input data to the CPU 201. Reference numeral 205 denotes a CRT (display controller), which provides display control for a display, not shown. Reference numeral 206 denotes a HD (hard disk). It should be noted that the HD 206 may be replaced by another external storage device such as an FD (floppy (registered trademark) disk) or an SRAM (nonvolatile memory). The HD 206 stores programs and data, which are loaded into the RAM 203 as the need arises.

Reference numeral 207 denotes a communication section, which controls network communications. The communication section 207 enables the server computer 130 to communicate with other computers and peripheral devices connected to the network 170. Reference numeral 208 denotes a system bus 208. The data which is exchanged between the above-mentioned component parts passes through the system bus 208.

The hardware configuration of the client computers 110 and 120 is identical with that of the server computer 130, and therefore description thereof is omitted.

FIG. 3 is a diagram showing a memory map assumed in a state in which a job management program according to the present invention is loaded into the RAM 203 and become ready to be executed by the CPU 201.

In FIG. 3, reference numeral 301 denotes a basic I/O program. Reference numeral 302 denotes an operating system such as the Windows (registered trademark) system. Reference numeral 303 denotes a job management program according to the present invention, reference numeral 304 denotes related data, described later, and reference numeral 305 denotes a working area which is used when the CPU 201 executes a program. The job management program according to the present invention and its related data are stored in a floppy (registered trademark) disk (FD) or a CD-ROM and is supplied therefrom to the server computer 130.

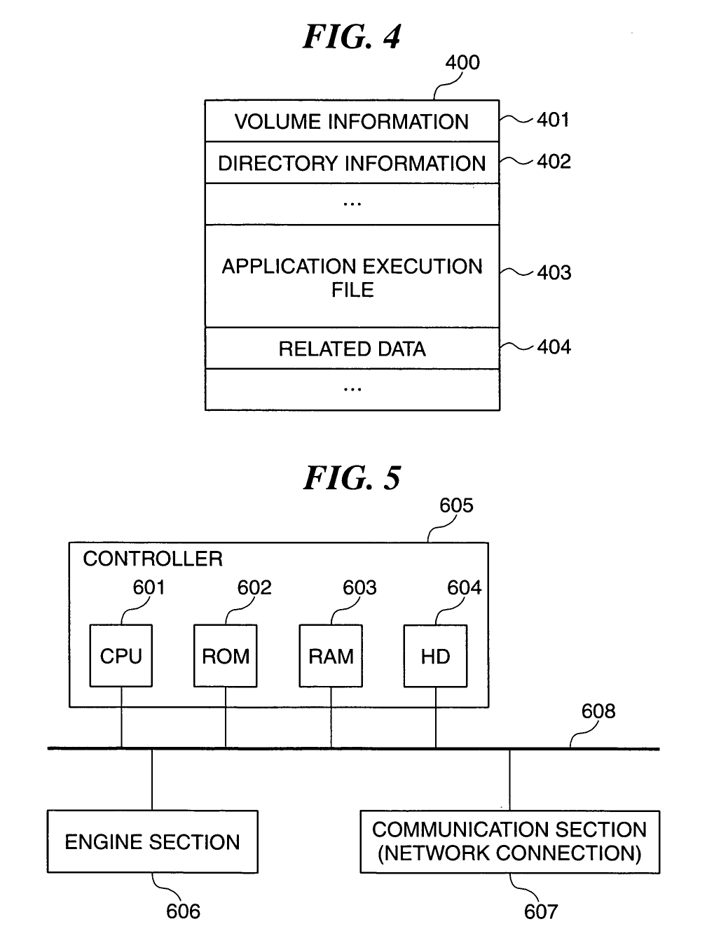

FIG. 4 is a diagram showing a memory map assumed in a state in which the job management program according to the present invention and its related data are stored in an FD or a CD-ROM. A storage area 400 of the FD or the CD-ROM is comprised of volume information 401 as the related data, directory information 402 as the related data, an execution file (application execution file) 403 of the job management program according to the present invention, job account related data file 404 as the related data, and so forth.

FIG. 5 is a block diagram showing the hardware configuration of the MFP 150 as a peripheral device.

In FIG. 5, reference numeral 605 denotes a controller which controls the overall operation of the peripheral device. The controller 605 is comprised of a CPU 601, a ROM 602, a RAM 603, and a HD 604.

The CPU 601 controls the overall operation of the peripheral device and carries out e.g. arithmetic operations. The ROM 602 is a read only memory as a storage area where a system activation program and others are stored. The RAM 603 is a random access memory as a data storage area. A HD 604 is a hard disk which can be replaced by another nonvolatile storage device such as an SRAM. A peripheral device having a job history holding function stores a job history in the RAM 603 or the HD 604.

Also, an operating system, a communication control program, and an engine control program are loaded into the RAM 603 and executed by the CPU 601. Reference numeral 606 denotes an engine section of the peripheral device, which carries out a printing operation and an image reading operation under the control of the controller 605. Specifically, the engine section 606 is comprised of a printer engine and/or a scanner engine. Reference numeral 607 denotes a communication section which controls network communication. The communication section 607 enables the peripheral device to communicate with the client computers 110 and 120 and the server computer 130. Reference numeral 608 denotes a system bus. The data which is exchanged between the above-mentioned component parts pass through the system bus 608.

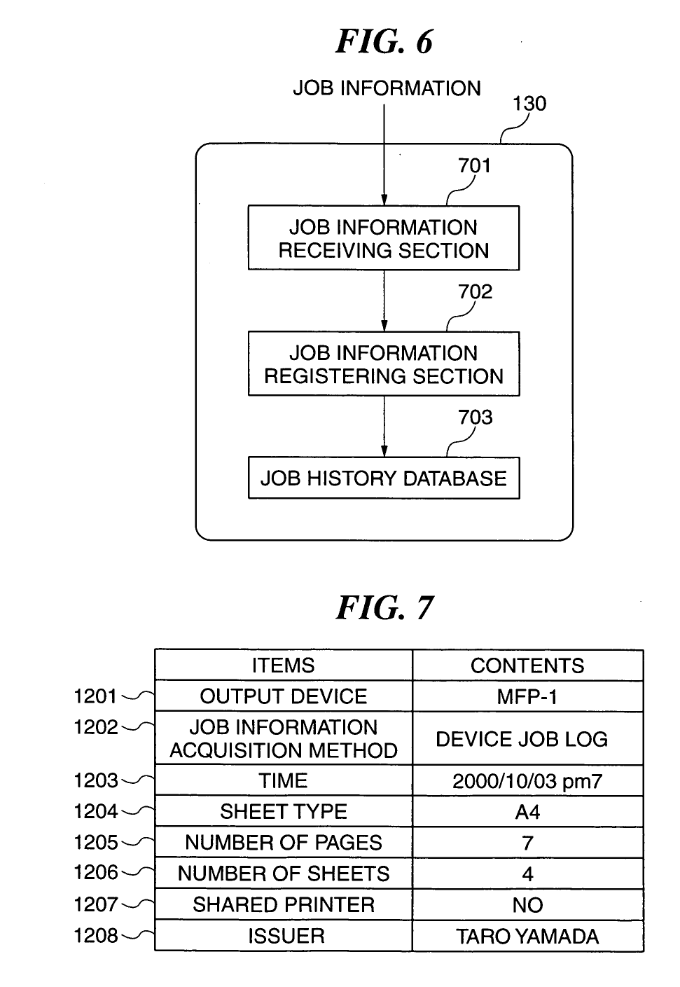

FIG. 6 is a block diagram showing the configuration of hardware which executes the job account server application 131 in FIG. 1.

The server computer 130 includes a job information receiving section 701 comprised of the communication section 207, a job information registering section 702 comprised of the CPU 201, and a job history database 703 comprised of the HD 208. These component parts 701 to 703 realize the functions of the job account server application 131.

The job information receiving,section 701 acquires job information from the job account client applications 114 and 124 and the peripheral devices 140 and 150 having the job history holding function via the network 170. The job information registering section 702 registers the job information, which has been received by the job information receiving section 701, in the job history database 703.

In the job account system according to the present embodiment, detailed job management is carried out by determining when, by whom and where a job was executed, as well as a peripheral device which was used to execute the job, and the volume of the job (the number of pages, the number of discharged sheets, and the type of sheets), by referring to data stored in the job history database 703.

FIG. 7 is a diagram showing the structure of one of pieces of job information registered in the job history database 703 in FIG. 6.

The job history database 703 is comprised of items and the contents thereof. In FIG. 7, item 1201 is indicative of an output device for a job, i.e. which peripheral device has processed a job. It should be noted that, in the case where a job does not involve the discharge of paper, information indicative of a file name (the job is scanning of original), information indicating that the job is a fax transmission, or information indicating that the job does not involve the discharge of paper, is recorded in the item 1201. Item 1202 indicates the method of acquiring job information. Examples of the method of acquiring job information include acquisition by hooking, acquisition by spooling, and acquisition using the job history holding function. Item 1203 indicates a job starting or ending time. Item 1204 denotes the type of discharged sheets. Item 1205 indicates the number of pages which have been output. Item 1206 indicates the number of discharged sheets. Item 1207 indicates whether or not the job has been input from a client computer to a shared printer. Item 1208 indicates the name of a user as the issuer of the job.

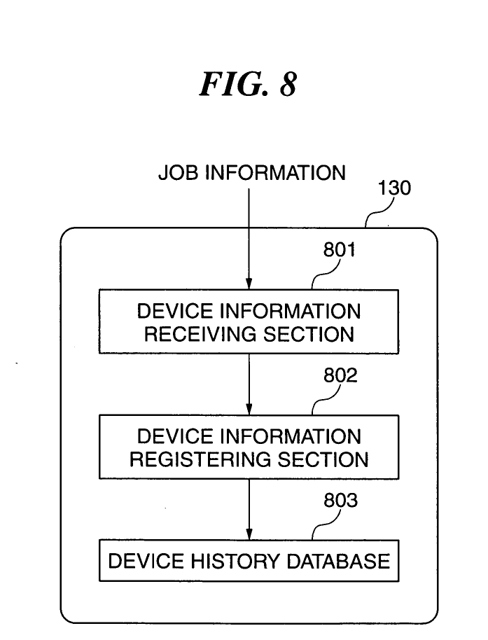

FIG. 8 is a block diagram showing the configuration of hardware which executes the job account server application 131 in FIG. 1. Although FIG. 7 shows the hardware configuration related to job information, FIG. 8 shows the hardware configuration related to device information.

The server computer 130 is comprised of a device information receiving section 801 comprised of the communication section 207, a device information registering section 802 comprised of the CPU 201, and a device history database 803 comprised of the HD 208. These component elements realize the functions of the job account server application 131.

The device information receiving section 801 acquires device information from the job account client applications 114 and 124 and the peripheral devices 140 and 150 having the job history holding function via a network. Also, the device information receiving section 801 acquires information relating to the communication status of the devices by communicating with the devices. The device information registering section 802 registers the device information received by the device information receiving section 801 in the device history database 803. The device information receiving section 801, the device information registering section 802, and the device history database 803 have many similarities to the job information receiving section 701, the job information registering section 702, and the job device history database 703. For this reason, the pair of the job information receiving section 701 and the device information receiving section 801, the pair of the job information registering section 702 and the device information registering section 802, and the pair of the job device history database 703 and the device history database 803 may be each configured as an integral form.

In the present job account system, the status of the devices (the latest time of printing, communication error log, and the current status) can be acquired by referring to data stored in the device history database 803, and hence the devices can be managed in a more efficient manner.

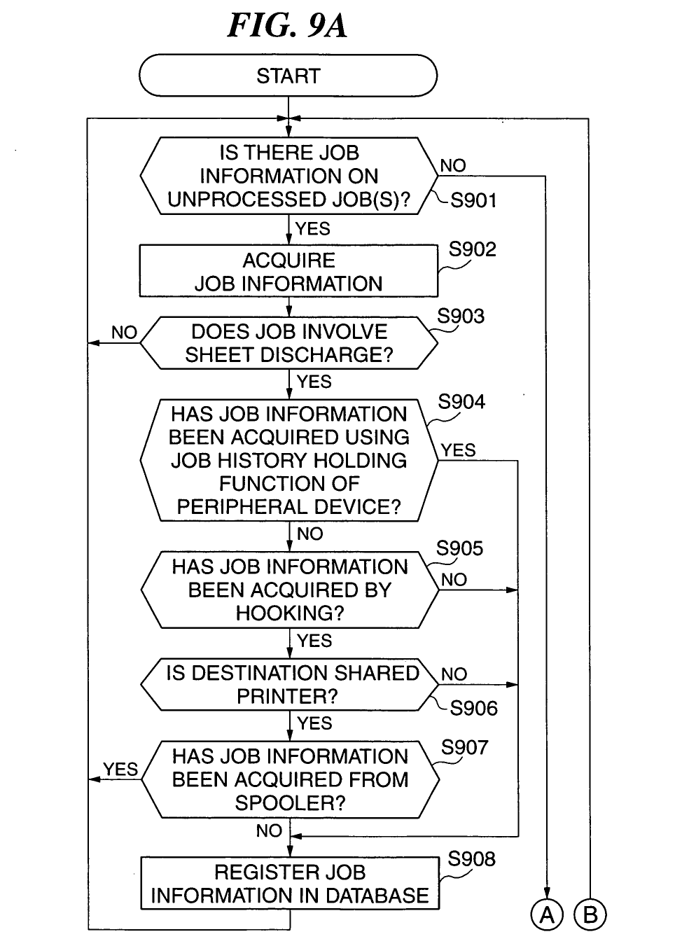

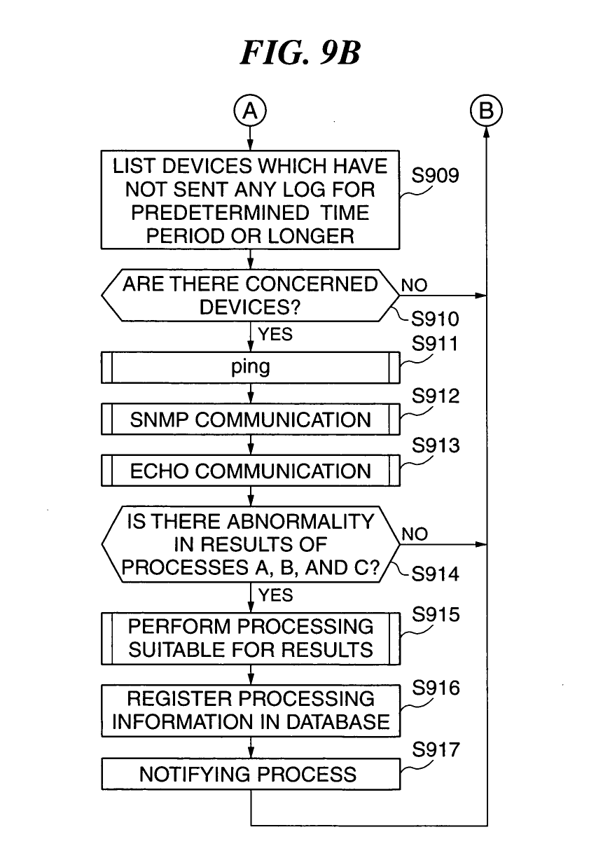

FIGS. 9A and 9B are flow chart showing an example of a self-diagnosing process executed by the server computer 130 appearing in FIG. 1. More specifically, FIGS. 9A and 9B are flow chart showing a process which is carried out when job information received by the job receiving section 701 is registered in the job history database 703 by the job registering section 702. This process is carried out by the job registering section 702 which is comprised mainly of the CPU 201.

First, it is determined whether or not there is job information on unprocessed job(s) in the job receiving section 701 (step S901). If there is job information on unprocessed job(s), processing in a step S909, described later, is performed.

On the other hand, if there is job information on unprocessed job(s), job information is acquired from the job receiving section 701 (step S902). Then, it is determined whether or not a job relating to the acquired job information involves sheet discharge (step S903). If the job does not involve sheet discharge, the process returns to the step S901, and on the other hand, if the job involves sheet discharge, it is determined whether the job information has been acquired from a peripheral device or not (step S904).

If it is determined in the step S904 that the job information has been acquired from a peripheral device, the job information is registered in the job history database 703 (step S908), and the process returns to the step S901. On the other hand, if it is determined in the step S904 that the job information has not been acquired from a peripheral device, it is determined whether or not the job information has been acquired by hooking (step S905). It should be noted that, as one method of determining whether or not the job information has been acquired by hooking, there is a method of determining by what OS job information has been acquired, because it is possible to determine whether or not job information has been acquired by hooking depending on the type of OS. For example, if OS1 is used as the OS on the client computer 110 and OS2 is used as the OS on the client computer 120, then if job information has been acquired by OS1, that job information has been acquired by hooking, and if the job information has been acquired by OS2, the job information has been acquired from the spooler 123.

If it is determined in the step S905 that the job information has not been acquired by hooking, the process proceeds to a step S908. It should be noted that, even if the job information has been acquired by hooking, the process proceeds to the step S908 in the case where a peripheral device to which a job is to be output has the job history holding function.

If it is determined in the step S905 that the job information has been acquired by hooking, it is determined whether or not the job information indicates that a device to which the job is to be output is a shared printer (step S906). If it is determined that the job information indicates that the device to which the job is to be output is not a shared printer, the process proceeds to the step S908. It should be noted that, even if the job information indicates that the device to which the job is to be output is not a shared printer, the process proceeds to the step S908 if the device to which the job is to be output is a peripheral device having the job history holding function.

If it is determined in the step S906 that the device to which the job is to be output is a shared printer, it is determined whether or not the job information has been acquired from the spooler of the client computer (e.g. the client computer 120) which manages the shared printer (step S907).

If it is determined in the step S907 that the job information has not been acquired from the spooler, the process proceeds to the step S908, and on the other hand, if it is determined in the step S907 that the job information has been acquired from the spooler, the process returns to the step S901. If, however, the job information has not been acquired from the spooler, the process proceeds to the step S908 in the case where the device to which the job is to be output has the job history holding function.

If it is determined in the step S901 that there is no job information on unprocessed job(s), devices are listed which have not sent any log from the job history database 703 to the server computer 130 for a predetermined period of time or longer (step S909). The predetermined period of time can be arbitrarily set by the user or the administrator. If there are one or more devices which have not sent any log to the server computer 130 for the predetermined period of time or longer, corresponding device information is acquired from the job history database 703.

Then, it is determined whether there are one or more devices which have not sent any log to the server computer 130 for the predetermined period of time or longer (step S910). If there is no device which has not sent any log to the server computer 130 for the predetermined period of time or longer, the process returns to the step S901. On the other hand, if there are one or more devices which have not sent any log to the server computer 130 for the predetermined period of time or longer, the process proceeds to steps S911, S912, and S913.

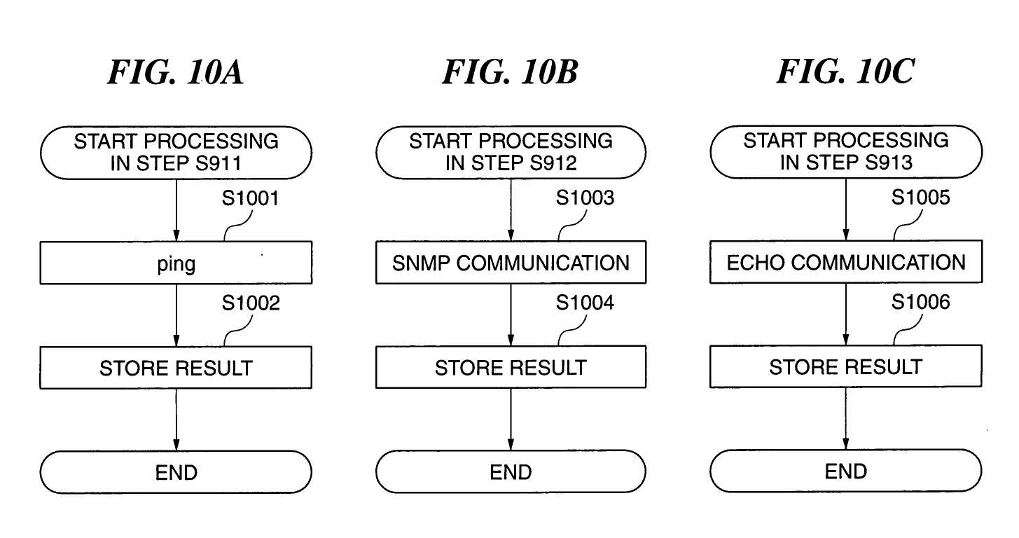

FIGS. 10A to 10C are flow charts showing processes which are carried out by the server computer 130 in the case where there are there are one or more devices which have not sent any log to the server computer 130 for the predetermined period of time or longer, in which FIG. 10A shows the contents of processing performed in the step S911 in FIG. 9B, FIG. 10B shows the contents of processing performed in the step S912 in FIG. 9B, and FIG. 10C shows the contents of processing performed in the step S913 in FIG. 9B. In the present embodiment, it is assumed that the process carried out by the server computer 130 proceeds to the steps S911, S912, and S913 in this order, but the process may proceed to the steps S912, S911, and S913 in this order, or may proceed to the steps S913, S911, and S912 in this order. That is, the order of processing should not be restricted.

The process carried out by the CPU 201 of the server computer 130 proceeds from the step S911 to a step S1001 in FIG. 10.

Then, a ping (Packet Inter Network Groper) command is sent to each of one or more devices which have not sent any log to the server computer 130 for the predetermined period of time or longer, to recognize the communication status of the device (step S1001), and whether or not there has been a reply in response to the ping command is recorded in the device history database 803 (step S1002), and the process proceeds to the step S912 (step S1003). Then, MIB (Management Information Base) communication with the device which has not sent any log to the server computer 130 for the predetermined period of time or longer is carried out according to SNMP (Simple Network Management Protocol) (step S1003), and the result of the MIB communication is recorded in the device history database 803 (step S1004), followed by the process proceeding to the step S913 (step S1005). Then, echo communication is carried out according to an office equipment unified control protocol (hereinafter referred to as “the protocol X”) via a port which is different from a port in the case of the SNMP (step S1005), and the result of the echo communication is recorded in the device history database 803 (step S1006), followed by the process proceeding to the step S914. Here, the protocol X is a unified equipment management protocol which carries out status acquisition, device control, job management, and so forth via two-way packet communication with various office equipment such as a printer, a facsimile, a copier, or a multi-function machine having the functions of a printer, a facsimile, and a copier, and is a protocol which is capable of carrying out echo communication via a different port from a port used for communication according to SNMP.

The results stored in the steps S1002, S1004, and S1006 are referred to from the device history database 803, and it is determined whether there is an abnormality in the device which has not sent any log to the server computer 130 for the predetermined period of time or longer (step S914). The criterions of determination are set in advance. If it is determined that there is no abnormality, the process returns to the step S901.

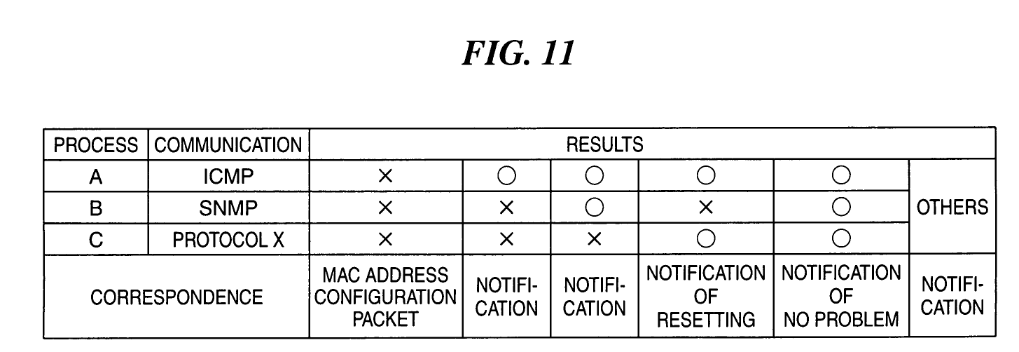

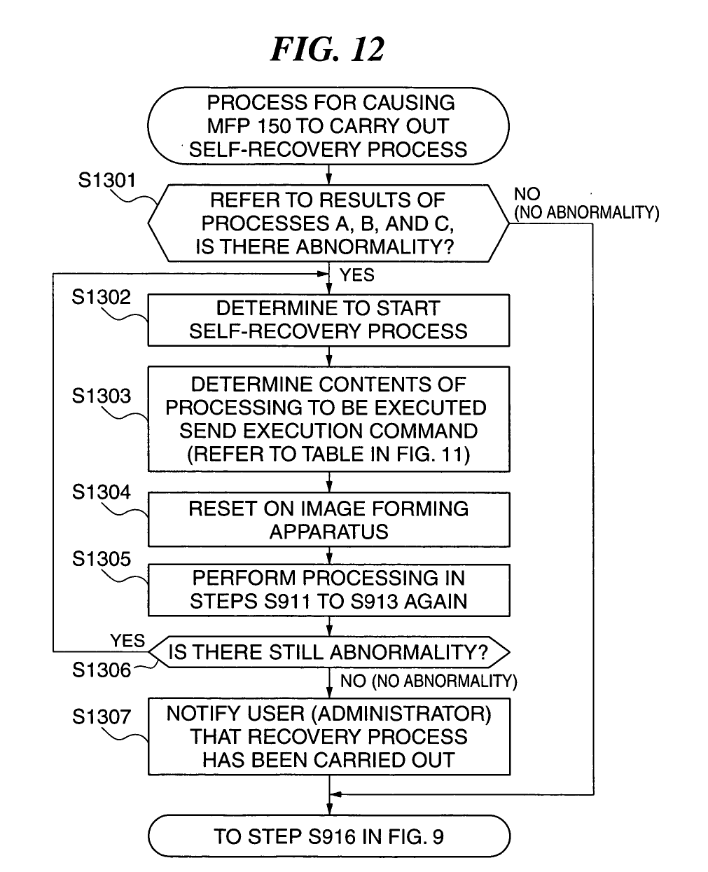

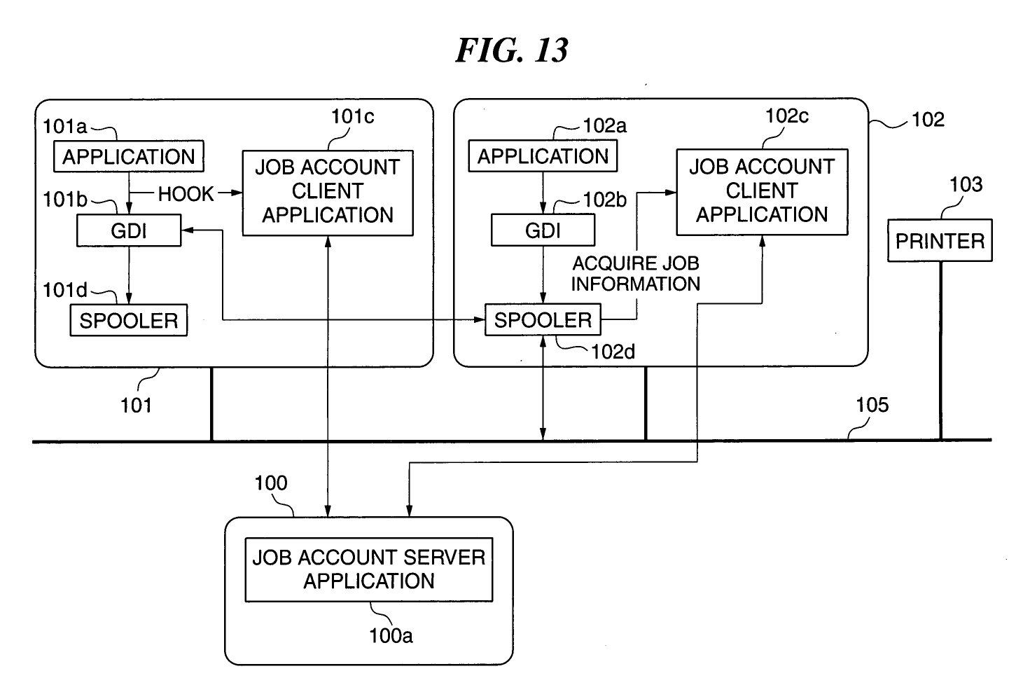

If it is determined in the step S914 that there is an abnormality, a process set in advance by an arbitrary means is determined. The arbitrary means may be a processing table and an initial file (Ini file), i.e. a universal means in software techniques. FIG. 11 shows an example of the processing table which describes the contents of processing set by the arbitrary means.

FIG. 11 is a diagram showing an example of the processing table executed by the CPU 201 of the server computer 130 based upon the results of processing in FIG. 10.

In FIG. 11, symbol A indicates results of the process in the step S911 in FIG. 9B, symbol B indicates results of the process in the step S912 in FIG. 9B, and symbol C indicates results of the process in the step S913 in FIG. 9B, i.e., data recorded in the device history database 803 in the steps S1002, S1004, and S1006 in FIG. 10.

The data recorded in the device history database 803 should not be necessarily called from the device history database 803 by means of e.g. a cash memory. It is assumed that various types of data can be stored in the steps S1002, S1004, and S1006, but here, data indicative of “◯” is held if there is simply a response in communication carried out in the steps S1001, S1003, and S1005, and data indicative of “ ” is held if there is no response (communication).

In the processing table shown in FIG. 11, if all the data stored as results of the processes A, B, and C are indicative of “X”, the concerned device sends a MAC address configuration packet. If the data stored as a result of the process A is indicative of “◯” and the data stored as results of the processes B and C are indicative of “X”, and the data stored as results of the processes A and B are indicative of “◯” and the data stored as a result of the process C is indicative of “X”, the CPU 201 of the server computer 130 displays the presence of an abnormality on the displays of the client computers 110 and 120 or the display of the server computer 130 so as to notify the administrator or the user of the abnormality. If the data stored as a result of the process A is indicative of “◯”, the data stored as a result of the process B is indicative of “X”, and the data stored as a result of the process C is indicative of “◯”, the CPU 201 of the server computer 130 resets the concerned device by means of the protocol X. On this occasion, the concerned device may be notified of the abnormality. If all the data stored as results of the processes A, B, and C are indicative of “◯”, it is determined that the device is normally operating, and on the displays of the client computers 110 and 120 or the display of the server computer 130, it is indicated that the concerned device is normally operating so that the administrator or the user is notified that the device is normally operating, or no processing is performed. Further, with different cases (which are considered unlikely) being taken into consideration, if combinations of data are different from those given above, an indication that there is an abnormality in the concerned device is displayed on the displays of the client computers 110 and 120 or the server computer 130 so as to notify the administrator or the user of the abnormality in the concerned device.

Then, the results of processing carried out according to the processing table in FIG. 11 are recorded in the device information recording section 803 (step S916). This updates the contents of processing for dealing with the abnormality of the device to more suitable ones. Then, the information recorded in the device information recording section 803 is called, and if necessary, a notification is sent to the user or the administrator (step S917), and the process returns to the step S901. If the notification processing performed in the step S917 includes displaying a message dialogue on the displays of the client computers 110 and 120 or the server computer 130, communicating with the user or the administrator using a universal means such as an electronic mail, or causing the printer 140, the MFP 150, or the printer 160 to output information recorded in the device information recording section 803.

Whether the above processing is necessary or not is determined depending on whether the criteria of judgment set in advance according to the status of peripheral devices, the levels of communication failure, and so forth by the user or the administrator are satisfied or not.

FIG. 12 is a flow chart showing a process which is carried out by the server computer 130 so as to cause the MFP 150 to carry out a self-recovery process.

The self-recovery process is a process in which predetermined processing is performed on the MFP 150 without any operation (e.g. ON/OFF switch depression) being required by the user in the case where an abnormality (a failure communication with a PC) occurs on the MFP 150 so that the MFP 150 can be automatically restored. This process is performed in the step S915 in FIG. 9B.

In the following description, it is assumed that a problem occurs in SNMP communication with the MFP 150.

First, the CPU 201 of the server computer 130 refers to the device history database 803 for the results stored in the steps S1002, S1004, and S1006 in FIG. 10 to determine whether or not there is an abnormality in the MFP 150 (step S1301). If there is no abnormality in the MFP 150, the process proceeds to the step S916, and on this occasion, information on time and others may be stored as a log in the HD 208.

If it is determined in the step S1301 that there is an abnormality in the MFP 150, it is then determined that the self-recovery process is to be started (step S1302), and the contents of processing to be performed are determined by referring to the processing table shown in FIG. 11, and a command for executing the processing is sent to the MFP 150 (step S1303). Here, it is assumed that there is an abnormality in SNMP communication, and hence, with reference to the processing table in FIG. 11, it is determined that resetting is to be performed according to the protocol X. An execution command for resetting is sent to the MFP 150 via communication according to the protocol X.

Then, the CPU 601 of the MFP 150 actually performs resetting (step S1304). The CPU 201 of the server computer 130 then executes the steps S911 to S913 in FIG. 9B (step S1305) to determine again whether there is an abnormality or not (step S1306). If there is an abnormality, the process returns to the step S1302, and on the other hand, if there is no abnormality, the completion of the self-recovery process carried out by the MFP 150 is displayed on the displays of the client computers 110 and 120 or the display of the server computer 130 so as to notify the user or the administrator that the self-recovery process carried out by the MFP 150 has been completed (step S1307), and the process proceeds to the step S916 in FIG. 9B.

The above described process enables peripheral devices to self-recover from a failure without troubling the user or the serviceperson.

It should be noted that the process is intended only to cause the MFP 150 to carry out the self-recovery process, but if a device has a program for executing the self-recovery process, the process may be applied to the device, too. Also, in the above description, it is assumed that a problem occurs in SNMP communication, but the protocol should not necessarily be SNMP.

In the step S1303, an execution command for causing the MFP 150 to carry out the self-recovery process is sent to the MFP 150, but if the MFP 150 is an image forming apparatus which can be provided with a high-level language such as the JAVA programming language, it can automatically recover from a failure, and hence it is unnecessary to send the execution command.

As described above, according to the present embodiment, it is detected whether or not job information on unprocessed job(s) is included in job information received from a peripheral device, and by means of a plurality of protocols, an abnormality of the peripheral device corresponding to the detected unprocessed job information is detected, and processing for dealing with the detected abnormality is performed. Therefore, if printing has not been performed for a predetermined period of time or longer, or if there is an abnormality in the status of a peripheral device, the status can be recognized by a plurality of diagnosing methods, so that job information can be managed in a more strict manner.

Also, the presence of an abnormality in a peripheral device is displayed on the displays of the client computers 110 and 120 or the display of the server computer 130, and the user or the administrator is notified of this. Therefore, the user or the administrator can know an abnormality in a peripheral device more quickly.

The MFP 150 can serve as a server computer and a client computer since it includes the controller 605 comprised of the CPU 601, ROM 602, RAM 603, and HD 604. Thus, the MFP 150 may be caused to carry out all the processes carried out by the server computer 130. In this case, the MFP 150 is provided with the job account server application 130 in FIG. 1, which eliminates the necessity of providing the server computer 130 in the job account system in FIG. 1. Further, the job information receiving section 701 and the device information receiving section 801 are implemented by the communication section 607, the job information registering section 702 and the device information registering section 802 are implemented by the CPU 601, and the job history database 703 and the device history database 803 are implemented by the HD 604. In the case where the MFP 150 executes the self-diagnosing function in FIGS. 9A and 9B, mainly the CPU 601 executes the function. The determination as to whether there is an abnormality or not, which is carried out in the step S914 in FIG. 9B, means whether there is a failure in communication between the MFP 150 and a concerned device.

This eliminates the necessity of additionally providing a server computer as a job managing apparatus, and enables construction of a job account system at a low cost.

Further, according to the present invention, the administrator can flexibly select and designate a process according to the type of usage of the job account system, so that peripheral devices can be used in an efficient manner. This enables construction of an environment in which jobs can be fairly allotted to

Further, it is to be understood that the object of the present invention may also be accomplished by supplying a system or an apparatus with a storage medium in which a program code of software, which realizes the functions of the above described embodiment is stored, and causing a computer (or CPU or MPU) of the system or apparatus to read out and execute the program code stored in the storage medium.

In this case, the program code itself read from the storage medium realizes the functions of the above described embodiment, and hence the program code and a storage medium on which the program code is stored constitute the present invention.

Further, it is to be understood that the functions of the above described embodiment may be accomplished not only by executing the program code read out by a computer, but also by causing an OS (operating system) or the like which operates on the computer to perform a part or all of the actual operations based on instructions of the program code.

Further, it is to be understood that the functions of the above described embodiment may be accomplished by writing the program code read out from the storage medium into a memory provided in an expansion board inserted into a computer or a memory provided in an expansion unit connected to the computer and then causing a CPU or the like provided in the expansion causing a CPU or the like provided in the expansion board or the expansion unit to perform a part or all of the actual operations based on instructions of the program code.

Further, the above program has only to realize the functions of the above-mentioned embodiment on a computer, and the form of the program may be an object code, a program executed by an interpreter, or script data supplied to an OS.

Examples of the storage medium for supplying the program code include a floppy (registered trademark) disk, a hard disk, a magnetic-optical disk, a CD-ROM, a CD-R, a CD-RW, a DVD (a DVD-ROM, a DVD-RAM, a DVD−RW, or a DVD+RW), a magnetic tape, a nonvolatile memory card, and a ROM. Alternatively, the program is supplied by downloading from another computer, a database, or the like, not shown, connected to the Internet, a commercial network, a local area network, or the like.

1. A job managing apparatus capable of connecting to an external apparatus via a network, and having a plurality of protocols, comprising:
a receiving device that receives job information from the external apparatus to which the job managing apparatus is connected;
a detecting device that detects whether or not job information on at least one unprocessed job is included in the received job information;
an abnormality detecting device that detects an abnormality in the external apparatus corresponding to the detected job information on at least one unprocessed job, by using the plurality of protocols; and
an abnormality handling process executing device that carries out a process to deal with the detected abnormality.

2. A job managing apparatus according to claim 1, wherein said abnormality handling process executing device comprises a notifying device that notifies a user that there is an abnormality in the external apparatus.

3. A job managing apparatus according to claim 1, comprising a storage device that stores a result of the process carried out by said abnormality handling process executing device.

4. A job managing apparatus according to claim 1, wherein the external apparatus comprises a self-recovery process executing device that carries out a self-recovery process when an abnormality occurs therein, and said abnormality handling process executing device comprises an execution command sending device that sends an execution command to the external apparatus so as to cause the external apparatus to carry out a self-recovery process.

5. A job managing apparatus according to claim 1, wherein the job managing apparatus comprises an image forming apparatus.

6. A job managing method carried out by a job managing apparatus capable of connecting to an external apparatus via a network, and having a plurality of protocols, the method comprising:
a receiving step of receiving job information from the external apparatus to which the job managing apparatus is connected;
a detecting step of detecting whether or not job information on at least one unprocessed job is included in the received job information;
an abnormality detecting step of detecting an abnormality in the external apparatus corresponding to the detected job information on at least one unprocessed job, by using the plurality of protocols; and
an abnormality handling process executing step of carrying out a process to deal with the detected abnormality.

7. A job managing method according to claim 6, wherein said abnormality handling process executing step comprises a notifying step of notifying a user that there is an abnormality in the external apparatus.

8. A job managing method according to claim 6, wherein the job managing apparatus comprises a storage device, the method comprising a storage step of storing a result of the process carried out in said abnormality handling process executing step in the storage device.

9. A job managing method according to claim 6, wherein the external apparatus comprises a self-recovery process executing device that carries out a self-recovery process when an abnormality occurs therein, and said abnormality handling process executing step comprises an execution command sending step of sending an execution command to the external apparatus so as to cause the external apparatus to carry out a self-recovery process.

10. A job managing method according to claim 6, wherein the job managing apparatus comprises an image forming apparatus.

11. A job managing program executable by a job managing apparatus capable of connecting to an external apparatus via a network, and having a plurality of protocols, comprising:
a receiving module for receiving job information from the external apparatus to which the job managing apparatus is connected;
a detecting module of detecting whether or not job information on at least one unprocessed job is included in the received job information;
an abnormality detecting module for detecting an abnormality of the external apparatus corresponding to the detected job information on at least one unprocessed job, by using the plurality of protocols; and
an abnormality handling process executing module for carrying out a process to deal with the detected abnormality.
